(19) United States
(12) Patent Application Publication
(10) Pub. No.: US 2024/0222103 A1
(43) Pub. Date: Jul. 4, 2024

(54) Internal Fragment Reduction in Top Down ECD Analysis of Proteins

(71) Applicant: DH Technologies Development Pte. Ltd., Singapore (SG)

(72) Inventors: Takashi BABA, Richmond Hill (CA); Keqin CHEN, Vaughan (CA)

(21) Appl. No.: 18/569,773

(22) PCT Filed: Jun. 16, 2022
(86) PCT No.: PCT/IB2022/055618

§ 371 Date: Dec. 13, 2023

Related U.S. Application Data
(60) Provisional application No. 63/211,181, filed on Jun. 16, 2021.

(51) Int. Cl. H01J 49/00; H01J 49/02; H01J 49/08; H01J 49/36

(52) U.S. Cl. CPC H01J 49/0054; H01J 49/022; H01J 49/08; H01J 49/36

(57) ABSTRACT

In one aspect, an electron capture dissociation (ECD) device for use in a mass spectrometer is disclosed, which is configured to trap precursor ions and cause the trapped precursor ions (or a portion thereof) to exit the ion trap, via radial excitation thereof by a resonant AC voltage, such that the released precursor ions can enter an ion-electron interaction region in which at least a portion of the precursor ions undergo fragmentation via interaction with an electron beam. The fragment ions are trapped and prevented from undergoing multiple dissociations. Once the fragmentation of the precursor ions is completed and/or after a predefined period, the fragment ions are released from the ECD to be received by downstream components of the mass spectrometer in which the ECD device is incorporated.

### BACKGROUND

The present teachings are generally related to ion dissociation devices, which can be incorporated in a mass spectrometer, and more particularly to ion dissociation devices that employ electron capture dissociation for ion fragmentation.

Mass spectrometry (MS) is an analytical technique for determining the elemental composition of test substances with both qualitative and quantitative applications. MS can be useful for identifying unknown compounds, determining the isotopic composition of elements in a molecule, determining the structure of a particular compound by observing its fragmentation, and quantifying the amount of a particular compound in a sample. Mass spectrometers detect chemical entities as ions such that a conversion of the analytes to charged ions must occur during the sampling process.

Some mass spectrometers include an ion reaction device, such as an electron capture dissociation device (ECD device), that can be employed to cause fragmentation of ions to allow obtaining additional structural information regarding ions under investigation. In particular, ECD is a promising technique for top-down sequencing of proteins. The use of ECD for mass analysis of proteins can, however, present certain challenges.

More specifically, when an electron is captured by protonated proteins, one backbone cleavage is induced so that one N terminal and C terminal fragment pair is produced. But the product fragments may have high charge states, which can result in efficient electron capture. When the second electron is captured by N terminal fragments, this process produces not only shorter N terminal fragments, but also produces fragments that do not have the N terminus of the original proteins (uncharged proteins). This type of fragments is called internal fragments. In some cases, ECD can lead to strong internal fragmentation via multiple electron capture, e.g., when ECD is employed for fragmentation of large proteins with a high protonated charge state, e.g., a protonated charge state over 30+.

In top-down sequencing of proteins, such internal fragments are not useful for sequencing because there are too many possibilities for combinations of starting amino acid residues and ending amino acid residues in the internal fragments. Such internal fragments can produce strong background peaks around the peak associated with a target m/z ratio with characteristic spectral profiles such as those shown in FIGS. 1A, 1B, and 1C. Such characteristic spectral profiles can cause great difficulty in identifying the peaks that are associated with highly charged terminal fragments, which in turn limits the size of the proteins that can be analyzed to those having less than about 300 amino acid residues.

Accordingly, there is a need for enhanced systems and methods for ion fragmentation, and particularly for such systems and methods for enhanced electron capture dissociation (ECD) of proteins for mass analysis.

### SUMMARY

In one aspect, an electron capture dissociation (ECD) device for use in a mass spectrometer is disclosed, which comprises a first set of L-shaped electrodes arranged in a multipole configuration, e.g., a quadrupolar configuration, and a second set of L-shaped electrodes arranged in a multiple configuration, e.g., a quadrupolar configuration. The first and the second electrode sets are positioned relative to one another so as to provide a first channel (herein also referred to as a “longitudinal channel”) extending along a longitudinal axis and having a proximal section comprising an inlet for receiving a plurality of precursor ions and having a distal section comprising an outlet through which ions can exit the first channel, and a second channel (herein also referred to as a “transverse channel”) extending along a transverse axis and intersecting the first channel in an electron-ion interaction region in which the precursor ions can interact with the electron beam to generate a plurality of product ions.

At least one RF power source is provided for application of one or more RF voltages to the first and second electrode sets for providing an electromagnetic field for providing radial confinement of the ions. One or more auxiliary electrodes are positioned relative to the first and second channels to which DC voltages can be applied for guiding the product ions into any of said proximal and distal sections of the first channel and trapping the product and precursor ions therein.

An AC excitation signal source is configured to apply a dipole AC excitation to at least one of the first and second electrode sets so as to resonantly excite at least a portion of a plurality of precursor ions trapped in any of the proximal and distal sections to enter said electron-ion interaction. The dipole AC excitation is further configured to be off-resonant relative to the product ions to ensure that the product ions remain trapped as the precursor ions are excited to cause their exit from the ion traps into the electron-ion interaction region. In some embodiments, the dipole AC excitation can be applied across two longitudinal T-shaped auxiliary electrodes, such as those discussed further below.

In some embodiments, the first and the second channels are substantially orthogonal relative to one another.

In some embodiments, the auxiliary electrodes have a T-shaped structure having a stem portion extending from a base portion. In some embodiments, a first pair of the auxiliary electrodes is positioned on opposed sides of said first channel with their stem portions extending to proximity of the longitudinal axis of the first channel. A second pair of the auxiliary electrodes are positioned on opposed sides of said second channel with their stem portions extending to proximity of the transverse axis.

The ECD device can further include a DC voltage source for applying the DC voltages to the auxiliary electrodes. The ECD device can also include a controller in communication with said RF and AC signal sources, as well as the DC voltage source, for controlling operations thereof.

In some embodiments, the AC excitation voltage has a frequency in a range of about 5-500 kHz, and an amplitude (e.g., peak-to-peak amplitude) in a range of about 0.1-10 volts. The applying frequency is matched to the secular frequency of the precursor ions in the proximal and distal linear ion traps.

In a related aspect, an electron capture device (ECD) for use in a mass spectrometer is disclosed, which includes a first set of L-shaped electrodes arranged in a multipole configuration (e.g., a quadrupolar configuration), a second set of L-shaped electrodes arranged in a multipole configuration (e.g., a quadrupolar configuration), said first and second electrode sets being positioned relative to one another so as to provide a first channel having a proximal section comprising an inlet for receiving a plurality of precursor ions and having a distal section comprising an outlet through which ions can exit the first channel, and a second channel intersecting the first channel in an electron-ion interaction region in which the precursor ions can interact with the electron beam to generate a plurality of product ions.

In some embodiments, at least one RF power source is provided for application of one or more RF voltages to the first and second electrode sets of the ECD for generating an electromagnetic field for providing radial confinement of the ions. One or more auxiliary electrodes can be positioned relative to the first and second channels to which DC voltages can be applied for guiding the product ions into any of the proximal and distal sections of the first channel and trapping the product and precursor ions therein. Further, an AC excitation signal source can be provided for applying an AC excitation signal to at least one of the first and second electrode sets so as to resonantly excite at least a portion of a plurality of precursor ions trapped in any of the proximal and distal sections such that the excited ions would exit those section and enter said electron-ion interaction.

In a related aspect, a mass spectrometer is disclosed, which comprises an ion guide for receiving a plurality of precursor ions, and an electron capture (ECD) device that is positioned downstream of the ion guide for receiving at least a portion of the ions exiting said ion guide. The ECD device comprises a first set of L-shaped electrodes arranged in a multipole configuration (e.g., a quadrupolar configuration), a second set of L-shaped electrodes arranged in a multipole configuration (e.g., a quadrupolar configuration), said first and second electrode sets being positioned relative to one another so as to provide a first channel having a proximal section comprising an inlet for receiving a plurality of precursor ions and having a distal section comprising an outlet through which ions can exit the first channel, and a second channel intersecting the first channel in an electron-ion interaction region in which the precursor ions can interact with the electron beam to generate a plurality of product ions.

The mass spectrometer can further include at least one RF power source for application of one or more RF voltages to the first and second electrode sets for generating an electromagnetic field for providing radial confinement of the ions. One or more auxiliary electrodes are positioned relative to said first and second channels to which DC voltages can be applied for guiding the product ions into any of the proximal and distal sections of the first channel and trapping said product and precursor ions therein. The mass spectrometer can also include an AC excitation signal source for applying an AC excitation signal to at least one of the first and second electrode sets so as to resonantly excite at least a portion of a plurality of precursor ions trapped in any of the proximal and distal sections such that the excited ions would exit those section and enter said electron-ion interaction.

In some embodiments, the first and the second channels are substantially orthogonal relative to one another.

The mass spectrometer can include a DC voltage source for supplying the DC voltages to the auxiliary electrodes.

The mass spectrometer can also include a mass analyzer positioned downstream of the ECD device for generating a mass spectrum of said product ions.

A controller in communication with the RF power source, the DC voltage source, and/or the AC excitation source for controlling thereof.

As noted above, in some embodiments, the dipole AC excitation voltage may be applied across the T-shaped auxiliary electrodes of an ECD according to the present teachings, which are positioned along a longitudinal axis of the ECD, or those of proximal and distal ion traps. By way of example, the precursor ions can be radially excited by the application of a dipole AC voltage applied between a top and a bottom T-shaped auxiliary electrodes.

In some embodiments, the mass spectrometer can include a gas source for introducing a gas into any of said longitudinal and transverse ion traps and said electron-ion interaction region.

The mass spectrometer can further include at least one controller for controlling the operation of various components of the mass spectrometer, including the RF and DC sources as well as the electron-emitting devices.

Further understanding of various aspects of the present teachings may be obtained by reference to the following detailed description in conjunction with the associated drawings, which are described briefly below.

### BRIEF DESCRIPTION OF THE DRAWINGS

FIGS. 1A, 1B, and 1C show that mass peaks associated with multiply fragmented precursor ion generated in a conventional ECD, which provide strong background peaks,

FIG. 2A schematically shows a conventional ECD device 100 in which both precursor and fragment ions remain exposed to an electron beam during the operation of the device,

FIG. 2B is a schematic view of an ECD device according to an embodiment of the present teachings,

FIG. 3A is a schematic perspective view of the ECD device depicted in FIG. 2B, illustrating a the quadrupole rod sets as well as two pairs of T-shaped auxiliary electrodes,

FIG. 3B is another schematic perspective view of the ECD device depicted in FIG. 2B,

FIG. 3C is a partial schematic perspective view of the ECD device depicted in FIG. 2B with one of the two sets of quadrupole rods removed to more clearly illustrate the T-shaped auxiliary electrodes,

FIG. 3D is another partial schematic perspective view of the ECD device depicted in FIG. 2B,

FIG. 3E is another partial schematic perspective view of the ECD device depicted in FIG. 2B,

FIG. 3F is another partial schematic perspective view of the ECD device depicted in FIG. 2B,

FIGS. 4A-4C schematically depict that, in use, initially a plurality of precursor ions is introduced into the ECD device,

FIGS. 5A-5C schematically depict that the precursor ions loaded into the ECD device can be trapped in a proximal and a distal portion of the ECD device and the trapped ions can optionally undergo cooling,

FIGS. 6A-6C schematically show that in some embodiments, subsequent to trapping the precursor ions and prior to the application of an AC excitation voltage, an electron beam can be switched on,

FIGS. 7A-7C schematically show that an electron beam and an AC excitation voltage can be substantially concurrently switched on, where the AC excitation voltage can cause at least a portion of the trapped precursor ions to exit the respective trap and interact with the electron beam,

FIGS. 8A-8C show optional cooling of the trapped product ions,

FIGS. 9A-9C schematically show the extraction of the product ions from the ECD device, and

FIG. 10 schematically depicts an example of a mass spectrometer in which an ECD device according to an embodiment of the present teachings in incorporated.

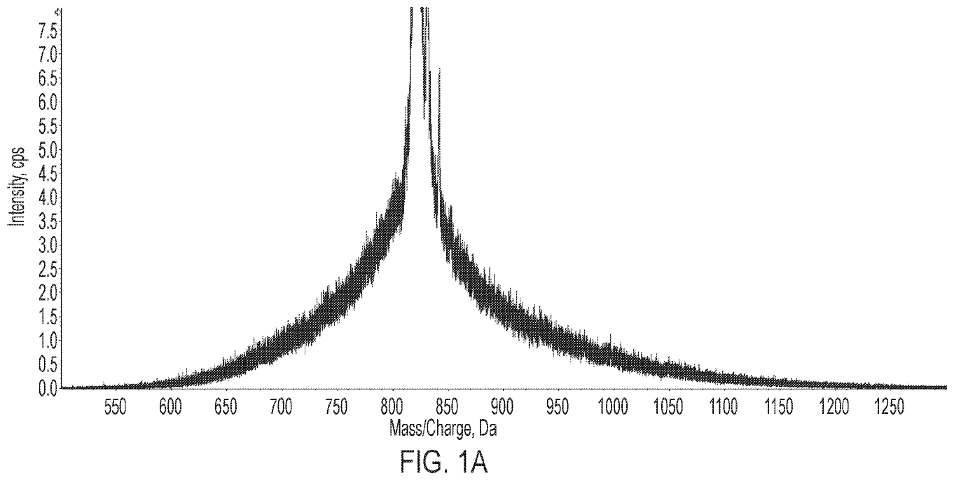

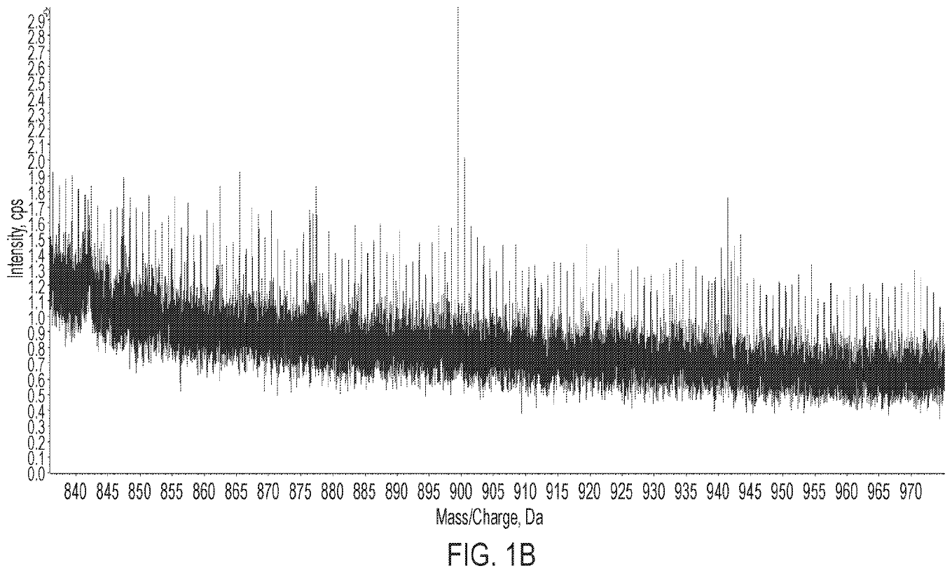

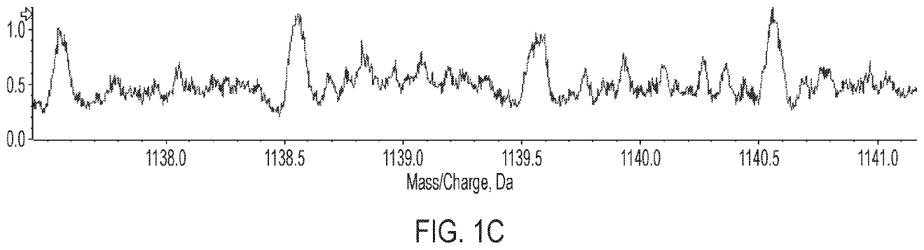

### DETAILED DESCRIPTION

The present teachings are generally directed to ECD devices that enhance the capability of conventional ECD devices, particularly in connection with their use in mass spectrometers for mass analysis of highly charged proteins.

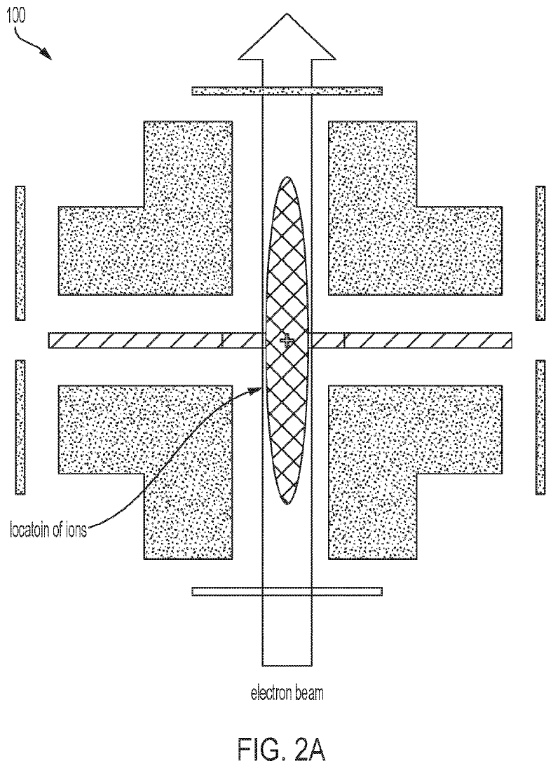

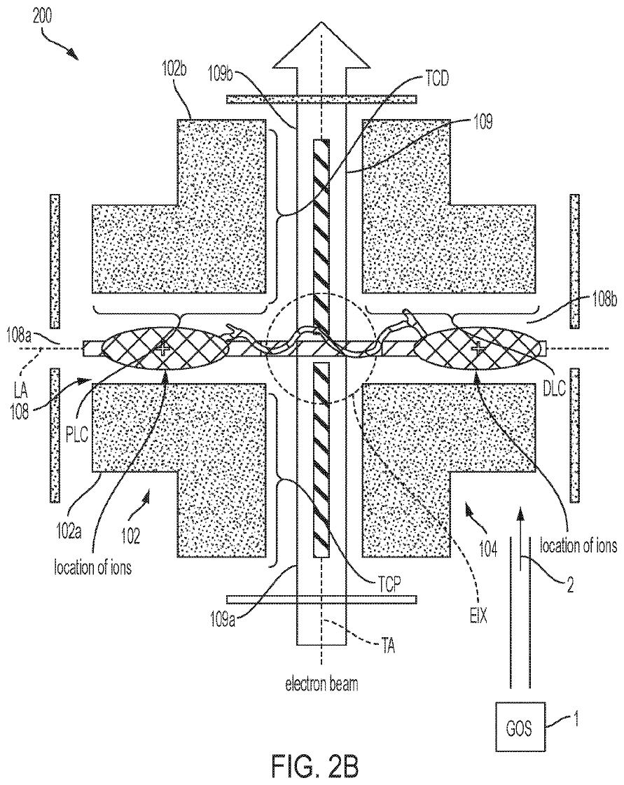

FIG. 2A schematically shows a conventional ECD device 100 in which both precursor and fragment ions remain exposed to an electron beam during the operation of the device. Such a configuration can, however, result in electron capture by the product ions, leading to fragmentation of at least some of the product ions (i.e., leading to multiple fragmentations of precursor ions to produce internal fragments). As discussed above, such multiple fragmentations of the precursor ions can add to the internal fragment background in the resultant mass spectrum, and hence render the spectrum analysis more complex.

In contrast, in an ECD device according to the present teachings, precursor ions can be spatially isolated from an electron beam and brought selectively into contact with the electron beam to cause fragmentation of at least a portion thereof, thereby generating a plurality of product ions. In such an ECD device, the product ions that are generated via fragmentation of a precursor ion can be isolated from the electron beam and hence prevented from undergoing additional interactions with the electron beam while other precursor ions undergo fragmentation via interaction with the electron beam. In this manner, multiple fragmentations of a precursor ion due to continued interaction of its fragments with the electron beam can be avoided.

With reference to FIGS. 2B as well as 3A-3F, an electron capture dissociation (ECD) device 200 according to an embodiment of the present teachings, which can be incorporated in a mass spectrometer, includes two sets of quadrupole rods 102 and 104, which are separated axially relative to one another.

In this embodiment, the rod set 102 includes four rods 102a, 102b, 102c, 102d, each of which has a generally L-shaped configuration characterized by an axial segment and a transverse segment (e.g., the axial segment 102ca and the transverse segment 102ct). Similarly, the rod set 104 includes four rods 104a, 104b, 104c, and 104d, each of which has a generally L-shaped configuration characterized by an axial segment and a transverse segment. In this embodiment, the longitudinal and transverse segments of each rod have a convex surface.

Both rod sets 102/104 are arranged relative to one another according to a quadrupolar configuration and provide a longitudinal channel 108, formed by the axial segments of the rods, and a transverse channel 109, formed by the transverse segments of the rods. The longitudinal channel 108 extends between an inlet 108a and an outlet 108b along an axial axis (LA), where a plurality of precursor ions can be introduced into the longitudinal channel 108 via the inlet 108a and product ions, generated via the interaction of precursor ions with an electron beam as discussed below, and any remaining precursor ions can exit the longitudinal channel through the outlet 108b. The transverse channel 109 includes two orifices 109a and 109b, each of which can function as an inlet for receiving an electron beam or as an outlet through which an electron beam introduced into the transverse channel via the opposed orifice can exit the transverse channel.

With particular reference to FIG. 2B, in this embodiment, an electron-emitting device 116 is positioned in proximity of the orifice 109a of the transverse channel and an electron-collecting device 117 is positioned in proximity of the orifice 109b of the transverse channel.

The electron-emitting device 116 includes a cathode (cathode 1) that can emit electrons in response to the application of a voltage thereto and a magnet (magnet 1) that can focus the electrons into an electron beam. The electron-emitting device 116 further includes a gate electrode (gate 1) and a pole electrode (pole 1) having openings through which the electron beam can pass to enter the transverse channel 109. The application of voltages to the gate electrode and the pole electrode can facilitate the introduction of the electron beam into the ECD device 100. In this embodiment, the pole electrodes are DC-biased at a voltage greater than that applied to the set of the L-shaped electrodes so as to confine the precursor ions and product ions when they reach the pole electrodes. Gate electrode bias is set at higher than that of the cathode bias to extract electrons from the electron source (=electron beam ON), or set at lower than that of the cathode bias to prevent electron emission (=electron beam OFF). An ion shield (shield 1) can surround the internal components of the electron-emitting device.

The electron-collecting device 117 is positioned in proximity of an outlet 109b of the transverse channel 109 to collect the electrons exiting the transverse channel. Similar to the electron-emitting device, the electron-collecting device 117 includes a pole electrode pole2 and a gate electrode gate2, which in this case help direct the exiting electrons onto a cathode 2, which can collect the electrons. Two magnets 2 produce a magnetic field along the transverse axis. Again, similar to the electron-emitting device, an iron shield can surround the internal components of the electron-collecting device.

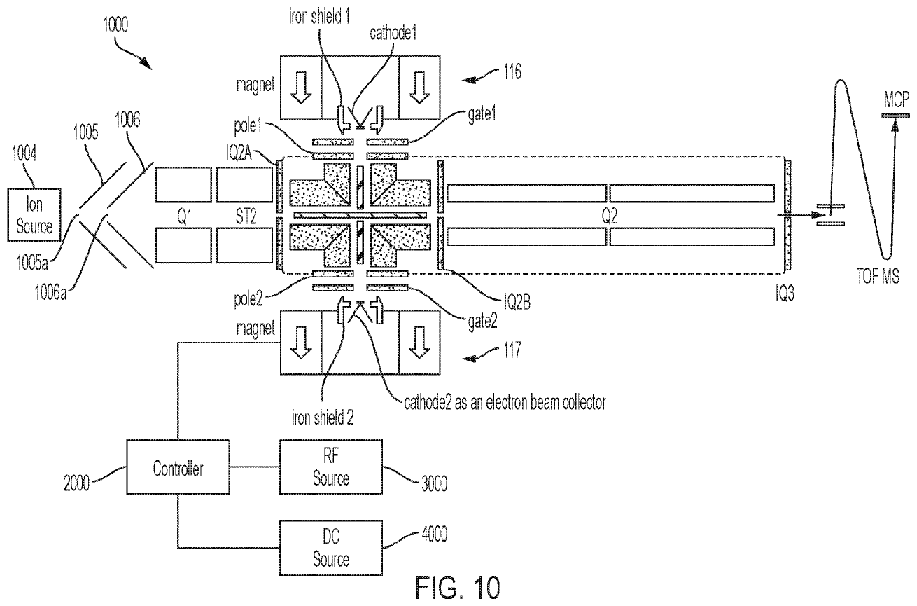

An RF source (such as RF source 1000 depicted in FIG. 10) can apply RF signals to the rod sets 102 and 104 so as to generate a quadrupolar electromagnetic field for providing radial confinement of the ions within the central channel 108 as well as the transverse channel 109.

The radial direction is used herein to refer to a direction perpendicular to direction of propagation of ions. For example, within the ion traps, the radial direction is orthogonal to the transverse axis (TA) and within the central channel, the radial direction is orthogonal to the longitudinal axis (LA).

Further, in the embodiment a source of gas 1 (e.g., nitrogen or helium) is fluidly coupled via a fluid channel 2 to the ECD device 200 to introduce a gas into the device. The gas can cool the precursor ions and facilitate their interaction with the electron beam. When the precursor ions are introduced into the reaction device, they have a high energy and can be spatially located outside of the electron beam. By cooling the gas, the ions will be staying closer to the potential minimum, and hence inside the electron beam.

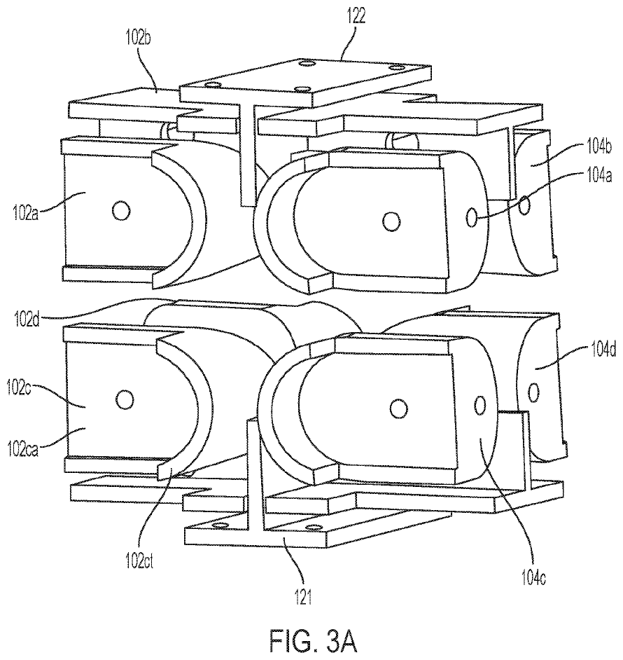

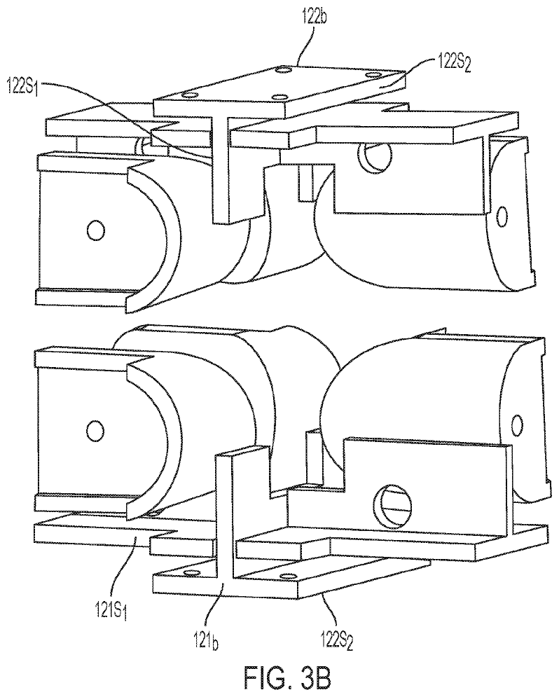

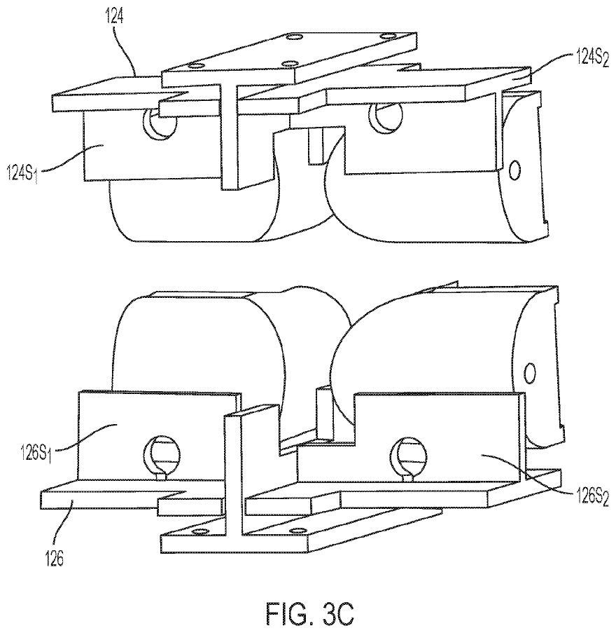

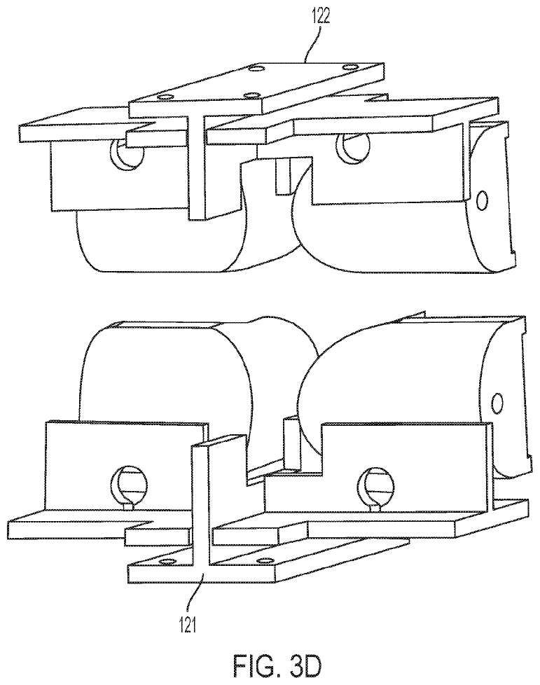

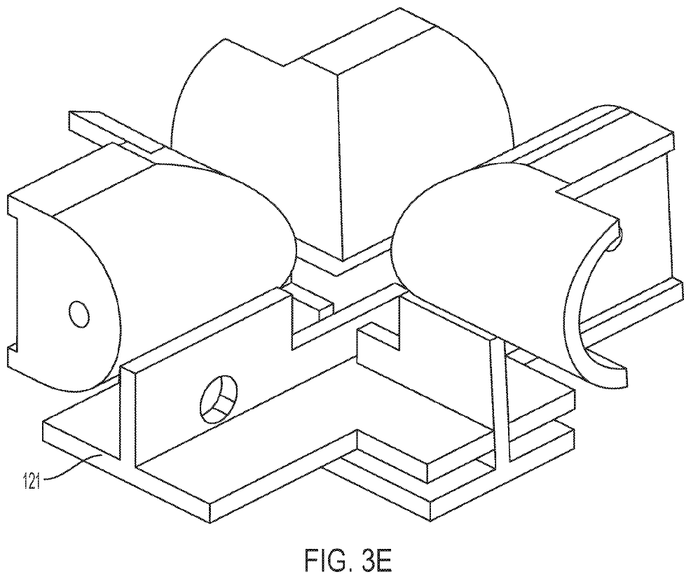

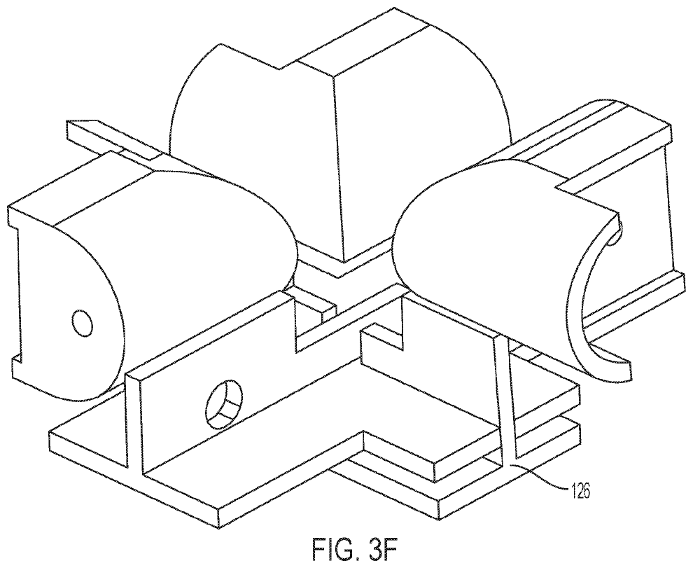

With particular reference to FIGS. 3A-3F, in this embodiment, the ECD device 200 further includes a pair of T-shaped electrodes 121 and 122 that are positioned, respectively, on the top and bottom sides of the longitudinal channel 108, where each T-shaped electrode includes a base (121b and 122b) and two stems (121s₁ and 122s₂) and stems (122s₁ and 122s₂) that extend from the base and penetrate at least partially into the longitudinal channel towards the longitudinal axis (LA). In some embodiments, the tip of the stems can be positioned at a distance between about 3-8 mm, from the longitudinal axis (LA).

More specifically, the stems 121s₁/122s₁ penetrate a proximal portion of the longitudinal channel (PLC) and the stems 122s₂/122s₂ penetrate a distal portion of the central channel (DLC), where product ions generated via the interaction of precursor ions with an electron beam can be trapped, as discussed in more detail below.

Further, with particular reference to FIG. 3C, a pair of opposed T-shaped auxiliary electrodes 124 and 126 is positioned on the top and the bottom sides of the transverse channel 109, where each electrode includes a base 124b/126b from which two stems (124s₁/124s₂) and (126s₁/126s₂) extend toward the transverse axis (TA). The stems 124s₁/126s₁ and 124s₂/126s₂ extend, respectively, into the proximal portion (TCP) and the distal portion (TCD) of the transverse channel, which are positioned on the opposite sides of the electron-ion interaction region. In some embodiments, the tips of the stems are positioned at a distance in a range of about 3-8 mm relative to the transverse axis (TA).

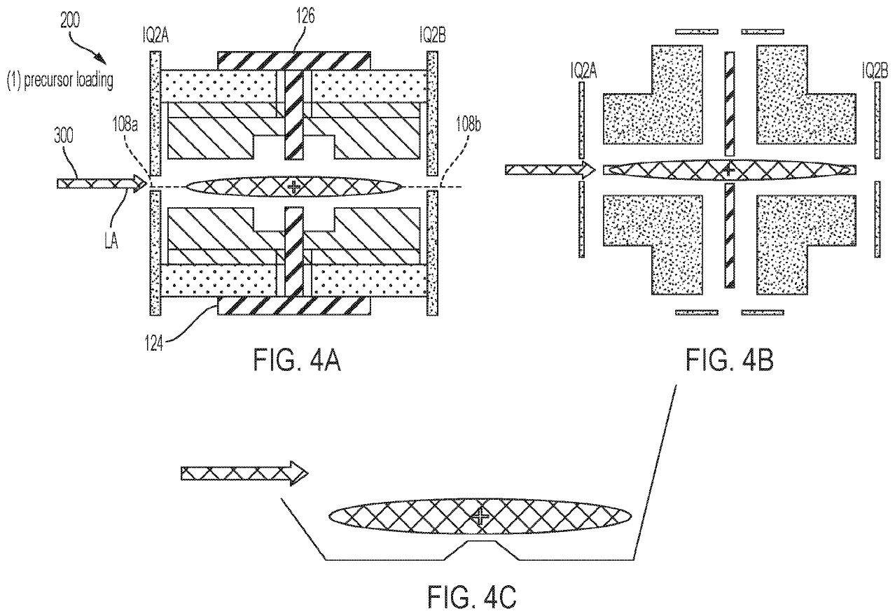

With particular reference to FIGS. 4A, 4B, and 4C, in use, a plurality of precursor ions 300 can be introduced into the ECD 200 via the inlet 108a of the longitudinal channel 108 such that precursor ions 300 are distributed along the longitudinal axis (LA). An ion lens IQ2A disposed in proximity of the inlet 108a to which a DC bias voltage can be applied is used to facilitate the transfer of the precursor ions into the longitudinal channel.

During the loading of the precursor ions, RF voltages will be applied to the rod sets to ensure radial confinement of the precursor ions. Further, a DC bias voltage is applied to an ion lens IQ2B disposed in proximity of the outlet 108b of the longitudinal channel to ensure the axial entrapment of the ions. Once the loading of the precursor ions is completed, the polarity of the voltage applied to the input lens IQ2A is switched to ensure that the received precursor ions are trapped along the longitudinal axis. A voltage applied across the T-shaped electrode at this stage can be, for example, in the range of about 5 to about 60 V, e.g., in the range of about 15 to about 30 V.

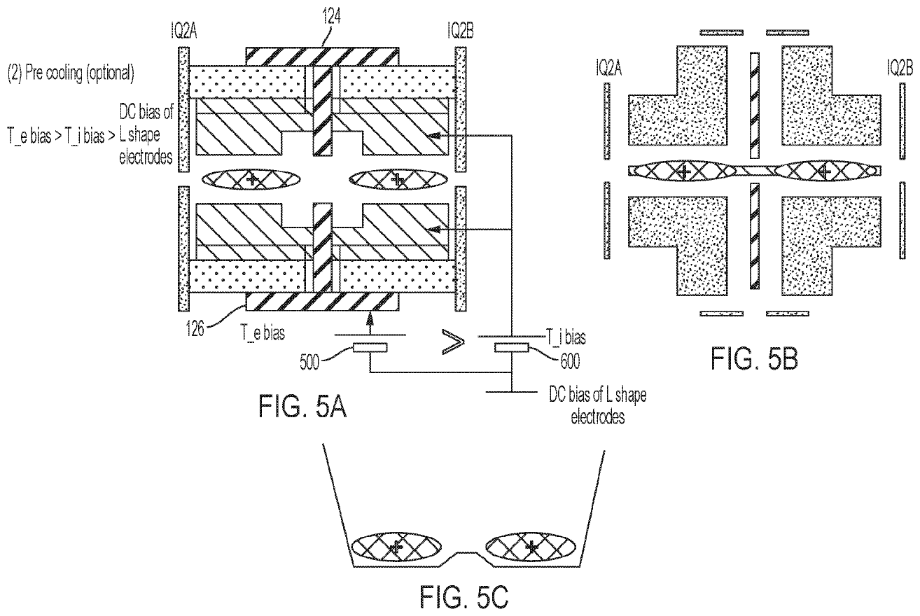

With reference to FIGS. 5A, 5B, and 5C, DC voltage sources 500 and 600 apply DC bias voltages to the pair of T-shaped auxiliary electrodes 124/126 relative to the L-shaped electrodes so as to cause a portion of the precursor ions to be trapped within the proximal portion of the longitudinal channel (herein also referred to as the “proximal ion trap”) and another portion of the precursor ions be trapped within a distal portion of the longitudinal channel (herein also referred to as the “distal ion trap”). In particular, the application of DC bias voltages to the T-shaped electrodes (124/126) can generate a potential barrier between the proximal and distal portions of the longitudinal channel, thereby facilitating trapping of the ions within those portions.

The continued application of RF voltages to the two rod sets ensures the radial confinement of the trapped ions. In some embodiments, the precursor ions trapped within the proximal and distal ion traps can undergo collisional cooling, e.g., during a defined temporal period. As shown in FIGS. 5A, 5B, and 5C, the transverse T bar bias (i.e., T_e bias) is set higher than the longitudinal T_bar bias (i.e., T_i bias) to push the precursor ions (positively charged ions in this embodiment) from the transverse axis to the longitudinal axis (i.e., into the proximal and distal ion traps). In order to avoid the diversion of the ions from the trap center (i.e., the crossing point of the longitudinal and the transverse axes), along the top and bottom directions, the T_e bias and T_i bias may be set higher than that of the L-shaped electrodes. By way of example, the T_i bias may be set in the range of about 5-60 V relative to that of the set of the L-shaped electrodes, and preferably in the range of about 15-30 V.

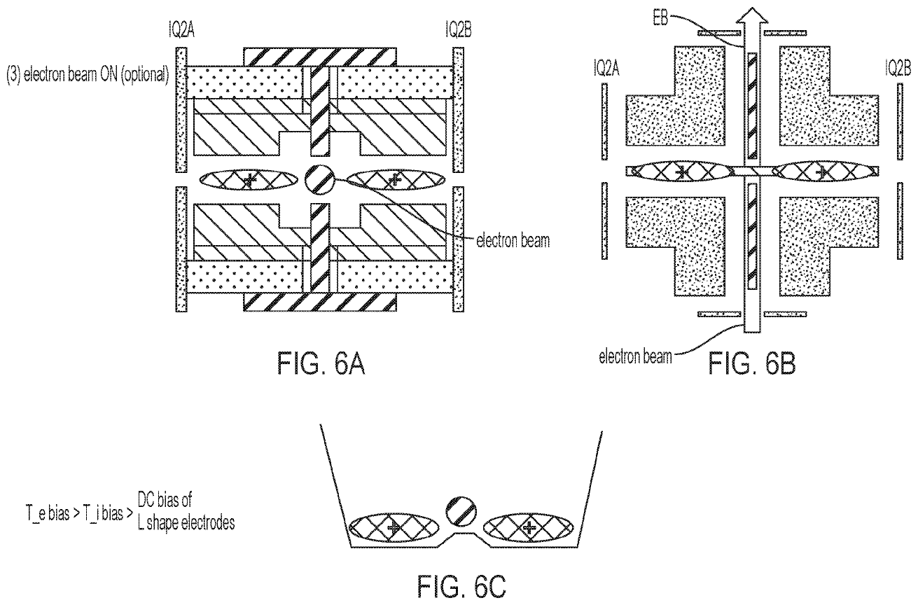

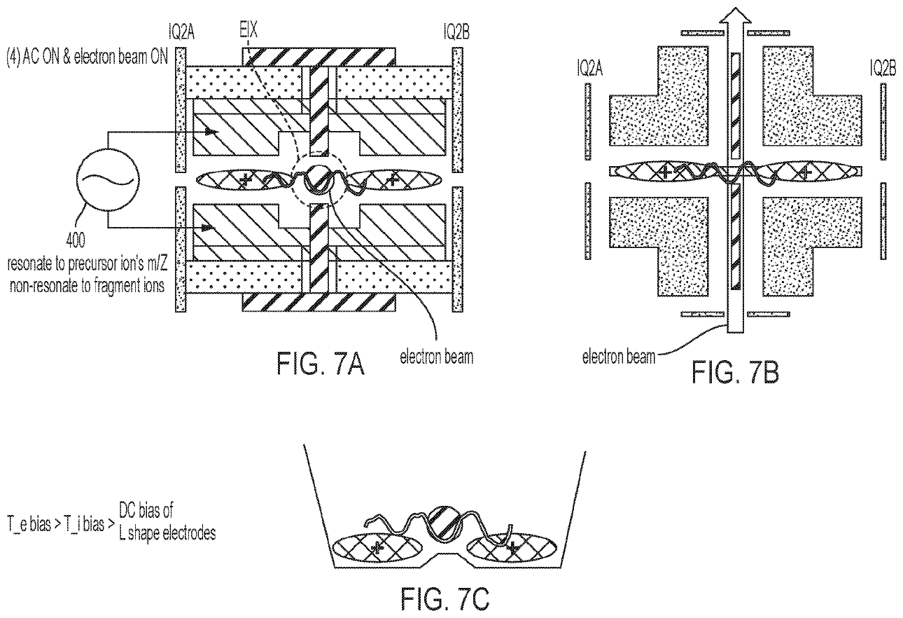

Referring now to FIGS. 6A, 6B, and 6C, in some cases, the electron beam can be turned on via activation of the electron-emitting device and, subsequently, a dipole AC excitation voltage is applied to at least one of the quadrupole rod sets to cause radial excitation of at least a portion of the precursor ions. Alternatively, the electron beam and the AC excitation voltage can be switched on substantially concurrently, as shown schematically in FIGS. 7A, 7B, and 7C.

In particular, an AC voltage source 400 can apply a dipole AC excitation voltage to the quadrupole rod sets (that is, the rod sets of both the proximal and distal ion traps). The applied AC excitation voltage is configured to have a frequency that is resonant with the secular frequency of the precursor ions so as to cause their radial excitation. At least a portion of such radially excited precursor ions can interact with the fringing fields at the distal end of the proximal ion trap or at the proximal end of the distal ion trap (i.e., the ends that are in proximity of the electron-ion interaction region), where such interactions convert the radial oscillations into axial oscillation and hence cause the excited ions to exit the ion trap and enter the ion-electron interaction region (EIX).

At least a portion of the ions entering the ion-electron interaction region interact with the electron beam and undergo fragmentation via electron capture dissociation (ECD) to generate a plurality of fragment ions. The fragment ions are then introduced into the opposed ion trap and are trapped therein. For example, the fragment ions generated via dissociation of precursor ions that exit the proximal ion trap to undergo dissociation within the electron-ion interaction region (EIX) are received by the opposed distal ion trap, and vice versa. The DC bias voltages help with the transfer of the fragment ions from the electron-ion interaction region into one of the transverse ion traps.

The AC excitation voltage is selected so as to be in resonance with the precursor ions and to be off-resonance relative to the fragment ions. In this manner, the AC excitation voltage causes the precursor ions to exit the ion traps for introduction into the electron-ion interaction region while the fragment ions remain confined within one of the two transverse ion traps and hence will not undergo multiple fragmentations.

The precursor ions that exit one of the proximal or distal ion traps and remain intact (unreacted) as they pass through the electron-ion interaction region are received by the opposed ion trap, where they will be excited by the resonance AC excitation to re-enter the electron-ion interaction region in order to undergo fragmentation. In this manner, substantially all of the precursor ions will be fragmented as they move back-and-forth between the two ion trap via passage through the electron-ion interaction region (EIX).

In other words, the precursor ions can be transferred from each of the proximal and distal ion traps into the electron-ion interaction region to generate a plurality of fragment ions via electron capture dissociation, where the fragment ions and any unreacted precursor ions are collected in the opposite ion trap. The fragment ions remain trapped in the ion traps as the AC excitation signal is off-resonance relative to the fragment ions. In this manner, the precursor ions can be converted into fragment ions while ensuring that the fragment ions can be prevented from undergoing multiple fragmentations.

In some embodiments, the AC excitation voltage can have a frequency in a range of about 5-500 kHz, and an amplitude (e.g., peak-to-peak amplitude) in a range of about 0.1-10 volts. The applied frequency is matched to the secular frequency of the precursor ions in the proximal and distal linear ion traps.

In some embodiments, the dipole AC excitation voltage can be applied to the T-bar electrodes in the longitudinal axis, or the proximal and distal ion traps. For example, the precursor ions can be radially excited by the dipole AC voltage applied between the top and bottom T bar electrodes.

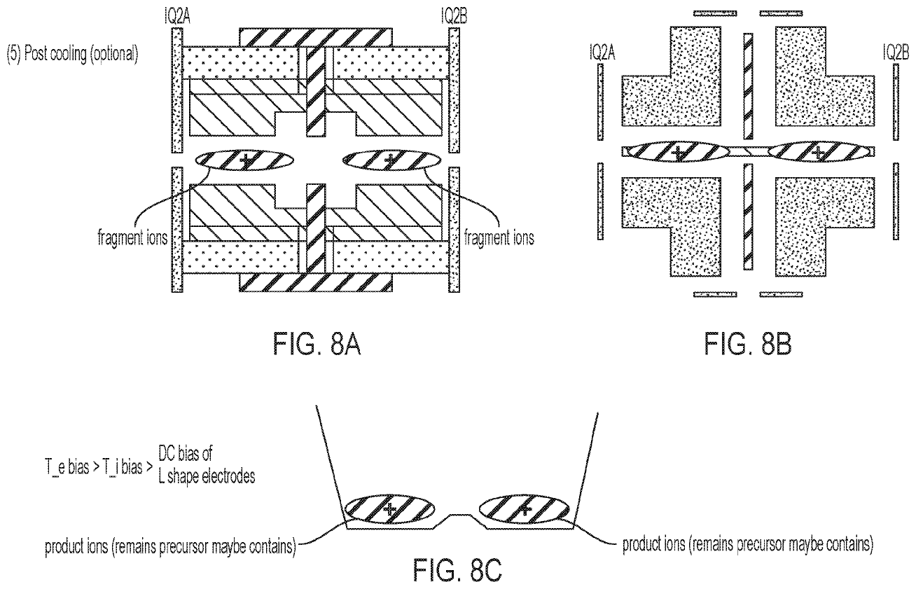

Once the fragmentation phase of the precursor ions is concluded, the AC excitation voltage and the electron beam can be discontinued and the fragment ions can optionally undergo cooling, e.g., via collisions with the background gas (See, e.g., FIG. 8). The bias DC voltage applied to the opposed T-shaped electrodes 124 and 126 can be maintained to preserve the DC potential barrier between the two transverse ion traps.

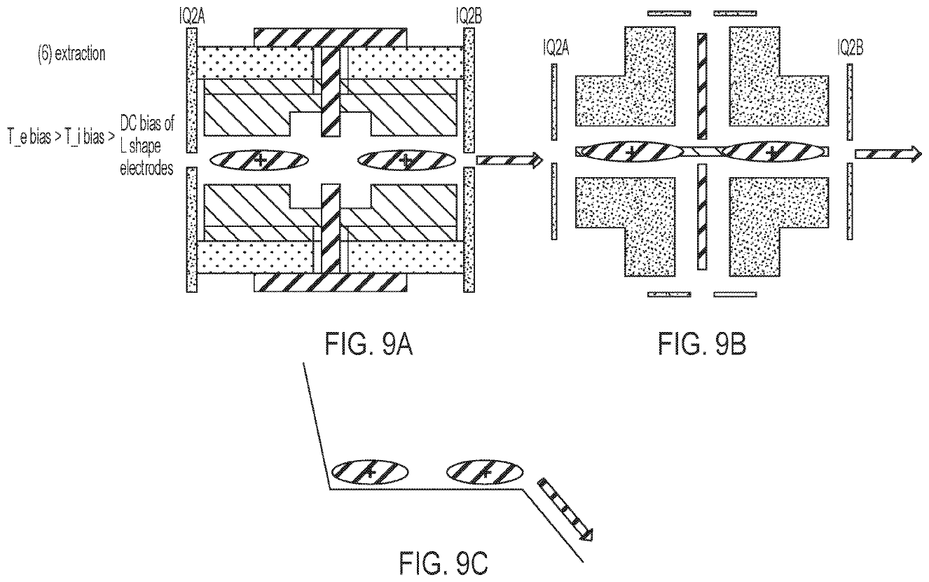

With particular reference to FIGS. 9A, 9B, and 9C, the extraction of the fragment ions from the longitudinal ion traps can be achieved by switching the DC voltage applied to the ion lens IO2B to lower the axial potential barrier, thereby allowing the ion fragments to exit the ion trap. During this stage, the voltages applied to the T-shaped electrodes in the longitudinal and transverse axes can be, for example, in the range of about 5 to about 25 V. The fragments ions (or any remaining precursor ions) can then exit through the opening provided in the ion lens IQ2B to be received by the downstream components of a mass spectrometer in which the ECD is incorporated.

An ECD device according to the present teachings can be incorporated in a variety of mass spectrometers. By way of example, FIG. 10 schematically depicts such a mass spectrometer 1000 according to an embodiment of the present teachings in which the aforementioned ECD device 200 is incorporated. In this embodiment, the mass spectrometer 1000 includes an ion source 1004 for generating a plurality of ions. The ions transit through openings 1005a and 1006a of a curtain plate 1005 and a downstream orifice plate 1006 to reach a quadrupole rod set Q1. Though not shown in this figure, an ion guide (Q0) can be positioned upstream of the Q1 quadrupole rod set to guide the ions into the downstream rod set Q1.

In this embodiment, the quadrupole rod set Q1 can be operated as a conventional transmission RF/DC quadrupole mass filter for selecting ions having an m/z value of interest or m/z values within a range of interest. By way of example, the quadrupole rod set Q1 can be provided with RF/DC voltages suitable for operation in a mass-resolving mode. For example, parameters of applied RF and DC voltages can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. It should be appreciated that this mode of operation is but one possible mode of operation for Q1.

In this embodiment, the ions selected by the Q1 mass filter are focused via a stubby lens ST1 into the ECD device 200 as precursor ions where they will undergo fragmentation to generate a plurality of fragment ions in a manner discussed above.

The generated fragment ions are received by the collision cell Q2, which includes quadrupole rod sets to which RF voltages can be applied for providing radial confinement of the ions. The collision cell Q2 includes a pressurized compartment that can be maintained, e.g., at a pressure in a range of about 1 mTorr to about 10 mTorr, though other pressures can also be used for this or other purposes. A suitable collision gas (e.g., nitrogen, argon, helium, etc.) can be provided by way of a gas inlet (not shown) to fragment at least a portion of the ions received by the collision cell. In some embodiments, a post-ECD fragmentation of the ions, e.g., via collision induced dissociation (CID) may be provide useful information. By setting the bias of the L shape electrodes higher than about 5-10 V, typically about 30-50V, additional collisional dissociation of the product ions in Q2 can be achieved.

The ion fragments then exit the collision cell Q2 to be received by a time-of-flight (ToF) mass spectrometer, which can generate a mass spectrum of the received ions.

In this embodiment, a controller 2000 can control the operation of the electron-emitting devices 116/117, e.g., to switch the electron-emitting device on and off. The controller 2000 can also control the operation of an RF voltage source 3000, which can be employed to apply RF voltages to the rods, as well as a DC voltage source 4000, which can apply bias voltages to the auxiliary electrodes.

Those having ordinary skill in the art will appreciate that various changes can be made to the above embodiments without departing from the scope of the invention.

What is claimed is:

1. An electron capture dissociation device (ECD) for use in a mass spectrometer, comprising:
a first set of L-shaped electrodes arranged in a multipole configuration,
a second set of L-shaped electrodes arranged in a multipole configuration,
said first and second electrode sets being positioned relative to one another so as to provide a first channel extending along a longitudinal axis and having a proximal section comprising an inlet for receiving a plurality of precursor ions and having a distal section comprising an outlet through which ions can exit the first channel, and a second channel extending along a transverse axis and intersecting the first channel in an electron-ion interaction region in which the precursor ions can interact with the electron beam to generate a plurality of product ions,
at least one RF power source for application of one or more RF voltages to said first and second electrode sets for providing a radial confinement electromagnetic field for providing radial confinement of the ions,
one or more auxiliary electrodes positioned relative to said first and second channels to which DC voltages can be applied for guiding the product ions into any of said proximal and distal sections of the first channel and trapping said product and precursor ions therein, and
an AC excitation signal source for applying a dipole AC excitation to at least one of said first and second electrode sets so as to resonantly excite at least a portion of a plurality of precursor ions trapped in any of the proximal and distal sections to enter said electron-ion interaction.

2. The ECD of claim 1, further comprising a system for introducing a gas into any of said longitudinal and transverse ion traps and said electron-ion interaction region.

3. The ECD of claim 1, further comprising at least one electron beam source positioned relative to an inlet of said transverse channel for introduction of an electron beam into said transverse channel.

4. The ECD of claim 3, wherein said at least electron beam source comprises at least one magnet for generating a magnetic field for guiding the electron beam into said transverse channel.

5. The ECD of claim 3, further comprising a controller for switching said electron beam source between an ON and an OFF state.

6. The ECD of claim 1, wherein said first and second channels are substantially orthogonal relative to one another.

7. The ECD of claim 1, wherein said dipole AC excitation signal is off-resonance relative to said product ions so as not to cause transfer of said product ions from any of said proximal and distal sections into said electron-ion interaction region.

8. The ECD of claim 1, wherein said auxiliary electrodes have a T-shaped structure having a stem portion extending from a base portion.

9. The ECD of claim 8, wherein a first pair of said auxiliary electrodes are positioned on opposed sides of said first channel with their stem portions extending to proximity of said longitudinal axis, or
wherein a second pair of said auxiliary electrodes are positioned on opposed sides of said second channel with their stem portions extending to proximity of said transverse axis.

10. (canceled)

11. The ECD of claim 1, further comprising a controller in communication with said RF, AC, and DC signal sources for controlling operation thereof.

12. The ECD of claim 9, further comprising a DC voltage source for applying a DC voltage to any of said first and second pairs of auxiliary electrodes.

13. The ECD of claim 1, wherein said AC voltage has a frequency in a range of about 5 to about 500 kHz, or
wherein said AC voltage has an amplitude in a range of about 0.1 volts and 10 volts.

14. (canceled)

15. A mass spectrometer, comprising:
an ion guide for receiving a plurality of precursor ions, and
an electron capture (ECD) device positioned downstream of said ion guide for receiving at least a portion of the ions exiting said ion guide, said ECD device comprising:
a first set of L-shaped electrodes arranged in a multipole configuration,
a second set of L-shaped electrodes arranged in a multiple configuration,
said first and second electrode sets being positioned relative to one another so as to provide a first channel having a proximal section comprising an inlet for receiving a plurality of precursor ions and having a distal section comprising an outlet through which ions can exit the first channel, and a second channel intersecting the first channel in an electron-ion interaction region in which the precursor ions can interact with the electron beam to generate a plurality of product ions,
at least one RF power source for application of one or more RF voltages to said first and second electrode sets for providing a radial confinement electromagnetic field for providing radial confinement of the ions,
one or more auxiliary electrodes positioned relative to said first and second channels to which DC voltages can be applied for guiding the product ions into any of said proximal and distal sections of the first channel and trapping said product and precursor ions therein, and
an AC excitation signal source for applying an AC excitation to at least one of said first and second electrode sets so as to resonantly excite at least a portion of a plurality of precursor ions trapped in any of the proximal and distal sections to enter said electron-ion interaction.

16. The mass spectrometer of claim 15, further comprising a system for introducing a gas into any of said longitudinal and transverse ion traps and said electron-ion interaction region.

17. The mass spectrometer of claim 15, further comprising at least one electron beam source positioned relative to an inlet of said transverse channel for introduction of an electron beam into said transverse channel.

18. The mass spectrometer of claim 17, further comprising a controller for switching said electron beam source between an ON and an OFF state.

19. The mass spectrometer of claim 15, wherein said first and second channels are substantially orthogonal relative to one another.

20. The mass spectrometer of claim 15, further comprising a DC voltage source for supplying said DC voltages.

21. The mass spectrometer of claim 15, further comprising a mass analyzer positioned downstream of said ECD device for generating a mass spectrum of said product ions.

22. The mass spectrometer of claim 20, further comprising a controller in communication with said RF power source, said DC voltage source and said AC excitation source for controlling thereof.
